(19) United States
(12) Patent Application Publication
(10) Pub. No.: US 2015/0199187 A1
(43) Pub. Date: Jul. 16, 2015

(54) EAGER TOKENIZATION OF PROGRAMS AND DISTRIBUTION OF TOKEN SEQUENCES TO CLIENT

(71) Applicant: GOOGLE INC., Mountain View, CA (US)

(72) Inventors: Matthias HAUSNER, Belmont, CA (US); Kasper Verdich LUND, Aarhus C (DK); Ivan POSVA, Mountain View, CA (US)

(73) Assignee: Google Inc., Mountain View, CA (US)

(21) Appl. No.: 13/648,028

(22) Filed: Oct. 9, 2012

Related U.S. Application Data
(60) Provisional application No. 61/544,921, filed on Oct. 7, 2011.

(51) Int. Cl. G06F 9/45

(52) U.S. Cl. CPC G06F 8/48

(57) ABSTRACT

Methods and systems are provided for increasing the speed at which source code is incrementally compiled by eagerly tokenizing the source code and retaining the sequence of tokens for later use of the compiler. The token sequence may be stored along with a snapshot of the execution state of the program. This snapshot represents the program logic as well as a specific state of the program. The snapshot can be sent to the client, which then recreates the state of the program. Fast startup time of programs on the client is achieved by incrementally compiling only the parts of the program that are executed. Rather than tokenizing the program each time a small portion of it is compiled, the sequence of tokens stored in the snapshot may be used.

The present application claims priority to U.S. Provisional Patent Application Ser. No. 61/544,921, filed Oct. 7, 2011, the entire disclosure of which is hereby incorporated by reference.

### TECHNICAL FIELD

The present disclosure generally relates to systems and methods for distributing programs to clients. More specifically, aspects of the present disclosure relate to increasing the startup time of programs on clients by incrementally compiling only the parts of the program that are executed.

### BACKGROUND

When programs are sent to client software, for example a web browser or smart phone device, the client has to compile the source code into a suitable executable form for the platform. This compilation step can significantly delay the time it takes for the application to start.

Some examples of conventional techniques for distributing programs to clients for compilation on the client side include byte code format of a virtual execution environment (e.g., Java byte code) and compressed intermediate program representation (e.g., abstract syntax trees).

### SUMMARY

This Summary introduces a selection of concepts in a simplified form in order to provide a basic understanding of some aspects of the present disclosure. This Summary is not an extensive overview of the disclosure, and is not intended to identify key or critical elements of the disclosure or to delineate the scope of the disclosure. This Summary merely presents some of the concepts of the disclosure as a prelude to the Detailed Description provided below.

One embodiment of the present disclosure relates to a computer-implemented method for incrementally compiling source code, the method comprising: eagerly tokenizing the source code into a sequence of tokens; storing the sequence of tokens together with a snapshot of an execution state of a corresponding program; and using the stored sequence of tokens to compile the corresponding program.

In another embodiment of the disclosure, the method for incrementally compiling source code further comprises sending the snapshot to a client, wherein the snapshot allows the client to recreate the specific state of the program.

In yet another embodiment of the disclosure, the method for incrementally compiling source code further comprises removing unnecessary data from the sequence of tokens stored in the array.

In one or more other embodiments of the disclosure, the methods and systems presented herein may optionally include one or more of the following additional features: the sequence of tokens are stored in an array; the snapshot represents program logic and a specific state of the program; and/or for each functional unit of the program, an index of a first token is stored.

Further scope of applicability of the present disclosure will become apparent from the Detailed Description given below. However, it should be understood that the Detailed Description and specific examples, while indicating preferred embodiments, are given by way of illustration only, since various changes and modifications within the spirit and scope of the invention will become apparent to those skilled in the art from this Detailed Description.

### BRIEF DESCRIPTION OF DRAWINGS

These and other objects, features and characteristics of the present disclosure will become more apparent to those skilled in the art from a study of the following Detailed Description in conjunction with the appended claims and drawings, all of which form a part of this specification. In the drawings:

FIG. 1 is a flowchart illustrating an example process for incrementally compiling source code according to one or more embodiments described herein.

The headings provided herein are for convenience only and do not necessarily affect the scope or meaning of the claimed invention.

In the drawings, the same reference numerals and any acronyms identify elements or acts with the same or similar structure or functionality for ease of understanding and convenience. The drawings will be described in detail in the course of the following Detailed Description.

### DETAILED DESCRIPTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other obvious features not described in detail herein. Additionally, some well-known structures or functions may not be shown or described in detail below, so as to avoid unnecessarily obscuring the relevant description.

The present disclosure presents methods and systems for speeding-up the incremental compilation of source code by eagerly tokenizing the source code and retaining the sequence of tokens for later use of the compiler. In at least some embodiments described herein, tokenization is the process of breaking-up a sequence of characters into pieces, parts, or terms, which are referred to as “tokens”. The technique described herein significantly reduces the time required to bootstrap applications written in “scripting” programming languages (e.g., languages where programs are distributed in source code rather than compiled executable files).

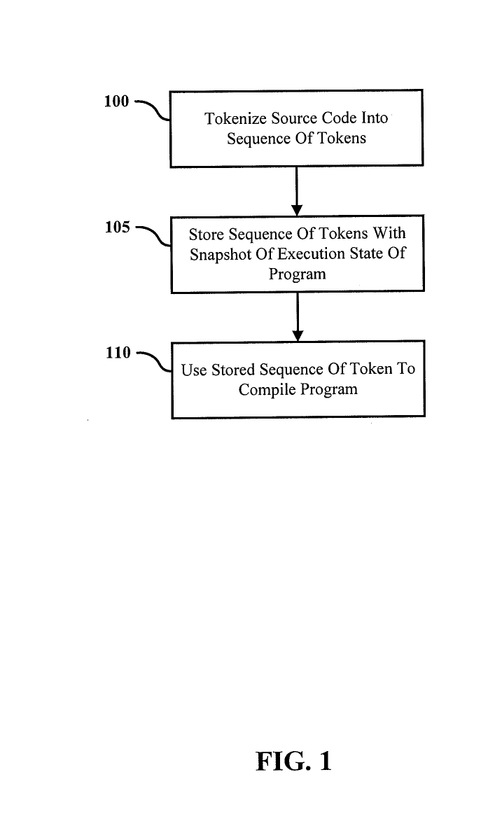

With reference to the example process illustrated in FIG. 1, in one or more embodiments, a token sequence may be stored along with a snapshot of the execution state of the program. This snapshot may represent the program logic as well as a specific state of the program. Depending on the implementation, the snapshot can be sent to a client, which then may recreate the state of the program using the program logic and state information contained in the snapshot.

As shown in FIG. 1, step 100 of the process includes tokenizing the source code into a sequence of tokens. The process then continues to step 105 where the sequence of tokens is stored together with a snapshot of the execution state of the corresponding program. Following step 105, the process then moves to step 110 where the corresponding program is compiled using the stored sequence of tokens.

Fast startup time of programs on the client may be achieved by incrementally compiling only the parts of the program that are executed. Rather than tokenizing the program each time a small portion of it is compiled, the sequence of tokens stored in the snapshot may be used. For each functional unit of the program, the index of the first token is stored. When the functional unit is compiled, the tokens are consumed from the stored sequence.

In at least one embodiment, the tokens are stored in an array. A compact representation removes all unnecessary, reconstructable data from the token array entries (e.g., source positions can be recomputed on demand). A minimal representation of which still allows random-access encodes every token in a single word. The word is either a fixed recognizable terminal (e.g., a parenthesis or a dot) or a reference to a literal (e.g., strings, numbers, identifier names).

Due to the linear structure of the token stream, look-ahead in a parser is efficient and straight-forward. The technique of the present disclosure may be used in various programming languages and scripting environments, such as Dart and also in virtual machine implementation.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A computer-implemented method for incrementally compiling source code of a program, the method comprising:
tokenizing the source code into a sequence of tokens;
storing the sequence of tokens together with a corresponding snapshot of an execution state of the program; and
incrementally compiling parts of the program that are executed using the stored sequence of tokens and the corresponding snapshot of the execution state.

2. The method of claim 1, wherein the sequence of tokens are stored in an array.

3. The method of claim 1, wherein the snapshot represents program logic and a specific state of the program.

4. The method of claim 3, further comprising sending the snapshot to a client, wherein the snapshot allows the client to recreate the specific state of the program.

5. The method of claim 1, wherein the parts of the program are functional units of the program, and further comprising:
for each functional unit of the program, storing an index of the first token in the sequence of tokens; and
compiling each functional unit using the sequence of tokens corresponding to the stored index and the snapshot of the execution state of the program.

6. The method of claim 2, further comprising removing unnecessary data from the sequence of tokens stored in the array.
